(19) United States
(12) Patent Application Publication
(10) Pub. No.: US 2026/0218906 A1
(43) Pub. Date: Jul. 30, 2026

(54) METHOD OF OPERATING A TURBINE ENGINE HAVING A FUEL MIXER ASSEMBLY

(71) Applicant: GENERAL ELECTRIC COMPANY, Evendale, OH (US)

(72) Inventors: Pabitra Badhuk, Bengaluru (IN); Pradeep Naik, Bengaluru (IN); Aritra Chakraborty, Bengaluru (IN); Arijit Sinha Roy, Bengaluru (IN); Bhavya Naidu Panduri, Bengaluru (IN); Prithiviraaj Pet T, Madurai (IN); Perumallu Vukanti, Bengaluru (IN); Karthikeyan Sampath, Bengaluru (IN); Narasimha Chiranthan Ranganatha, Bengaluru (IN); Michael T. Bucaro, Arvada, CO (US)

(21) Appl. No.: 19/037,573

(22) Filed: Jan. 27, 2025

(51) Int. Cl. F23R 3/28; F23R 3/14

(52) U.S. Cl. CPC F23R 3/286; F23R 3/14

(57) ABSTRACT

A turbine engine having a compressor section, combustion section, and turbine section in serial flow arrangement. The combustion section has a fuel source, an air source, and a fuel mixer assembly. The fuel mixer assembly includes a mixing tube body at least partially defining a mixing channel. The mixing tube body includes a first set of fuel passages and a second set of fuel passages fluidly coupling the fuel source to the mixing channel, wherein the first set of fuel passages supplies fuel to the mixing channel at low power conditions and the second set of fuel passages supplies fuel to the mixing channel at high power conditions.

### TECHNICAL FIELD

The disclosure generally relates to a method of operating a turbine engine, more specifically to a method of operating a turbine engine having a fuel mixer assembly.

### BACKGROUND

Turbine engines are driven by a flow of combustion gases passing through the engine to rotate a multitude of turbine blades, which, in turn, rotate a compressor to provide compressed air to the combustor for combustion. A combustor is provided within the turbine engine and is fluidly coupled to a turbine into which the combusted gases flow.

Turbine engines and particularly gas or combustion turbine engines are rotary engines that extract energy from a flow of combusted gases passing through the engine and flowing over a multitude of airfoils, including stationary vanes and rotating turbine blades.

Historically, hydrocarbon fuels are used in the combustor of a turbine engine. Generally, air and fuel are fed to a combustion chamber, the air and fuel are mixed, and then the fuel is burned in the presence of the air to produce hot gas. The hot gas is then fed to a turbine where it cools and expands to produce power. By-products of the fuel combustion typically include environmentally unwanted byproducts, such as nitrogen oxide and nitrogen dioxide (collectively called NOₓ), carbon monoxide (CO), unburned hydrocarbons (UHC) (e.g., methane and volatile organic compounds that contribute to the formation of atmospheric ozone), and other oxides, including oxides of sulfur (e.g., SO₂ and SO₃).

To reduce the environmentally unwanted byproducts, other fuels, such as hydrogen, are being explored. Hydrogen or hydrogen mixed with another element has a higher flame temperature than traditional hydrocarbon fuels. That is, hydrogen or a hydrogen mixed fuel typically has a wider flammable range and a faster burning velocity than traditional hydrocarbon-based fuels.

### BRIEF DESCRIPTION OF THE DRAWINGS

In the drawings:

FIG. 1 is a schematic representation of a turbine engine, the turbine engine including a compression section, a combustion section, and a turbine section, in accordance with an aspect of the present disclosure.

FIG. 2 is a cross-sectional view of the combustion section taken along line II-II of FIG. 1, further illustrating a fuel mixer assembly coupled to a combustion chamber, in accordance with an aspect of the present disclosure.

FIG. 3 is a schematic cross-sectional view of a portion of the combustion section as seen from sectional line III-III of FIG. 2, further illustrating an exemplary configuration of the fuel mixer assembly in accordance with various aspects described herein.

FIG. 4 is a schematic view illustrating a fuel post in the set of fuel posts of a fuel mixer assembly in accordance with various aspects described herein.

FIG. 5A is a schematic view illustrating a fuel post in the set of fuel posts of a fuel mixer assembly in accordance with various aspects described herein.

FIG. 5B is a schematic view illustrating a fuel post in the set of fuel posts of a fuel mixer assembly in accordance with various aspects described herein.

FIG. 5C is a schematic view illustrating a fuel post in the set of fuel posts of a fuel mixer assembly in accordance with various aspects described herein.

FIG. 6 is a flowchart illustrating a method of operating an engine in accordance with aspects of the disclosure.

FIG. 7 is a variation of the schematic cross-sectional view of the airfoil assembly of FIG. 3, in accordance with various aspects described herein.

FIG. 8 is a variation of the schematic cross-sectional view of the airfoil assembly of FIG. 3, in accordance with various aspects described herein.

FIG. 9A is a variation of the schematic cross-sectional view of the airfoil assembly as seen from sectional line IX-IX of FIG. 8, in accordance with various aspects described herein.

FIG. 9B is another variation of the schematic cross-sectional view of the airfoil assembly as seen from sectional line IX-IX of FIG. 8, in accordance with various aspects described herein.

FIG. 9C is yet another variation of the schematic cross-sectional view of the airfoil assembly as seen from sectional line IX-IX of FIG. 8, in accordance with various aspects described herein.

FIG. 10 is a variation of the schematic cross-sectional view of the airfoil assembly of FIG. 8, in accordance with various aspects described herein.

### DETAILED DESCRIPTION

Aspects of the disclosure herein are directed to a method of operating a turbine engine, more specifically, to a method of operating a turbine engine having a fuel mixer assembly supplying fuel from a fuel source to a combustor for combustion within a turbine engine. With some aspects, the disclosed turbine engine and fuel mixer assemblies can be utilized with gaseous fuel, such as hydrogen.

Gaseous fuels, such as hydrogen and non-diluent hydrogen, have faster flame speeds and higher flame temperatures than that of liquid fuels or atomized liquid fuels, which while beneficial in high power conditions (e.g., takeoff, climb), these fuels can result in flashback or flame holding along portions of the fuel mixer assembly or the surrounding environment. Such flashback or flame holding can impact durability of the fuel mixer assembly and poor mixing can produce unwanted byproducts, such as NOₓ. Having a flow of fuel straddled by flows of air in a fuel mixer assembly when forming a fuel-air mixture can improve mixing and the fuel-air mixture can have greater flame stability and reduced NOₓ emissions.

During low power conditions (e.g., startup, ground idle, cruise,), air provided within a fuel mixer assembly can offer less momentum when interacting and mixing with fuel, where fuel tends to spread out before being ignited in the combustion chamber. As such, other means to improve fuel and air mixedness can be relied upon. For example, flame stability and NOₓ emissions can also be affected by one or both of swirling and turbulence of fuel and air prior to combustion. Having one or both of fuel and air with swirl, having structures to produce turbulence, or utilizing a combination thereof can improve fuel air mixing and thus, improve flame stability and reduced NOₓ emissions.

The fuel mixer assembly herein mixes air (e.g., supplied from the air supply) and fuel (e.g., supplied from the fuel supply) to produce a relatively high momentum, low swirl or non-swirl fuel-air mixture at both high power and low power conditions.

For purposes of illustration, the present disclosure will be described with respect to a turbine engine (e.g., a gas turbine engine). It will be understood, however, that aspects of the disclosure described herein are not so limited. A combustor as described herein can be implemented in various engines, including but not limited to turbojet, turboprop, turboshaft, and turbofan engines. Aspects of the disclosure discussed herein can have general applicability within non-aircraft engines having a combustor, such as other mobile applications and non-mobile industrial, commercial, and residential applications.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first” and “second” can be used interchangeably to distinguish one component from another and are not intended to signify location or importance of the individual components. The terms “forward” and “aft” refer to relative positions within a turbine engine or vehicle, and refer to the normal operational attitude of the turbine engine or vehicle. For example, with regard to a turbine engine, forward refers to a position closer to an engine inlet and aft refers to a position closer to an engine exhaust.

As used herein, the term “upstream” refers to a direction that is opposite the fluid flow direction, and the term “downstream” refers to a direction that is in the same direction as the fluid flow. The term “fore” or “forward” means in front of something and “aft” or “rearward” means behind something. For example, when used in terms of fluid flow, fore or forward can mean upstream and aft or rearward can mean downstream.

The term “fluid” can be a gas, a liquid, or a combination thereof. The term “fluidly coupled” means that a fluid is capable of making the connection between the areas specified.

As used herein, the term “fuel” can be one or more of liquid or gaseous hydrogen, natural gas, diesel, and Jet-A, and can incorporate one or both of water and steam.

As used herein, the term “shear” relates to the dynamic effects (e.g., changes in velocity with respect to position) a flow of fluid exerts on its surroundings. For example, a flow of air intercepting a flow of fuel can impart shear, to some degree, over the fuel. The term “high shear zone” can refer to a portion in a fuel mixer assembly where increased shear in imparted by high-momentum air to fuel.

Additionally, as used herein, the terms “radial” or “radially” refer to a direction away from a common center. For example, in the overall context of a turbine engine, radial refers to a direction along a ray extending between a center longitudinal axis of the engine and an outer engine circumference.

All directional references (e.g., radial, axial, upward, downward, front, back, behind, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate structural elements between a collection of elements and relative movement between elements unless otherwise indicated. As such, connection references do not necessarily infer that two elements are directly connected and in fixed relation to one another. The exemplary drawings are for purposes of illustration only the dimensions, positions, order, and relative sizes reflected in the drawings attached hereto can vary.

The singular forms “a”, “an”, and “the” include plural references unless the context clearly dictates otherwise. Furthermore, as used herein, the term “set” or a “set” of elements can be any number of elements, including only one.

Uses of “and” and “or” are to be construed broadly. For example and without limitation, uses of “and” do not necessarily require all elements or features listed, and uses of “or” are inclusive unless such a construction would be illogical.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Additionally, as used herein, a “controller” can include a component that provides instruction, control, operation, or any form of communication for operable components to effect the operation thereof. A controller can include any known processor, microcontroller, or logic device, including, but not limited to: field programmable gate arrays (FPGA), an application specific integrated circuit (ASIC), a full authority digital engine control (FADEC), a proportional controller (P), a proportional integral controller (PI), a proportional derivative controller (PD), a proportional integral derivative controller (PID controller), proportional resonant controller (PR), a hardware-accelerated logic controller (e.g. for encoding, decoding, transcoding, etc.), the like, or a combination thereof. Non-limiting examples of a controller can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types. In another non-limiting example, a controller can also include a data storage component accessible by the processor, including memory, whether transient, volatile or non-transient, or non-volatile memory.

Additional non-limiting examples of the memory can include Random Access Memory (RAM), Read-Only Memory (ROM), flash memory, or one or more different types of portable electronic memory, such as discs, DVDs, CD-ROMs, flash drives, universal serial bus (USB) drives, the like, or any suitable combination of these types of memory. In one example, the program code can be stored within the memory in a machine-readable format accessible by the processor. Additionally, the memory can store various data, data types, sensed or measured data values, inputs, generated or processed data, or the like, accessible by the processor in providing instruction, control, or operation to effect a functional or operable outcome, as described herein. In another non-limiting example, a controller can compare a first value with a second value, and operating and controlling operations of additional components based on the satisfying of that comparison. For example, when a sensed, measured, or provided value is compared with another value, including a stored or predetermined value, the satisfaction of that comparison can result in actions, functions, or operations controllable by the controller.

As used herein, “power conditions” can refer to the amount of power or propulsive thrust produced by the engine. Power conditions can include high power conditions (e.g., climb, takeoff) and, relatively, low power conditions (e.g., cruise, startup, ground idle). A controller, as used herein, can affect the operation of components in accordance to power conditions of the engine during operation. Power conditions can be defined as a percentage of utilized engine power relative to a total engine power during operation. As used herein, “low power conditions” refers to the operation of an engine at greater than or equal to 0% total engine power and less than or equal to 20% total engine power. As used herein, “high power conditions” refers to the operation of an engine at greater than 20% total engine power and less than or equal to 100% total engine power.

As used herein, “swirl” refers to imparting a force upon fluid (e.g., air, fuel, or mixtures thereof) flowing in a fluid passage during or prior to emission to a portion of a turbine engine (e.g., a fuel mixer assembly inlet or mixing channel) that establishes a rotational, or swirling, path for emitted fluid therethrough. As such, while a non-swirled or pre-swirled flow of fluid has an axial component of momentum collinear to an axis of flow, imparting force to the fluid to define a tangential component of momentum in the fluid that is collinear to a discrete axis (e.g., a centerline of the fluid passage, or axis of flow in a downstream portion of a turbine engine) can push fuel along a rotational path, or swirled path. The amount of swirl along a flow of fluid can be quantified by a swirl number. The swirl number is defined as an integral of the tangential momentum to the axial momentum of the flow of fluid at an instance along the fluid passage or downstream within the portion of the turbine engine.

Additionally, as used herein, “co swirl” refers to two or more flows of fluid having swirl with tangential components of momentum in the same direction relative to a shared axis that can lessen shear between the flows of fluid. As used herein, “counter swirl” refers to two or more flows of fluid having swirl with tangential components of momentum in different directions relative to a shared axis that can increase mixing between the flows of fluid.

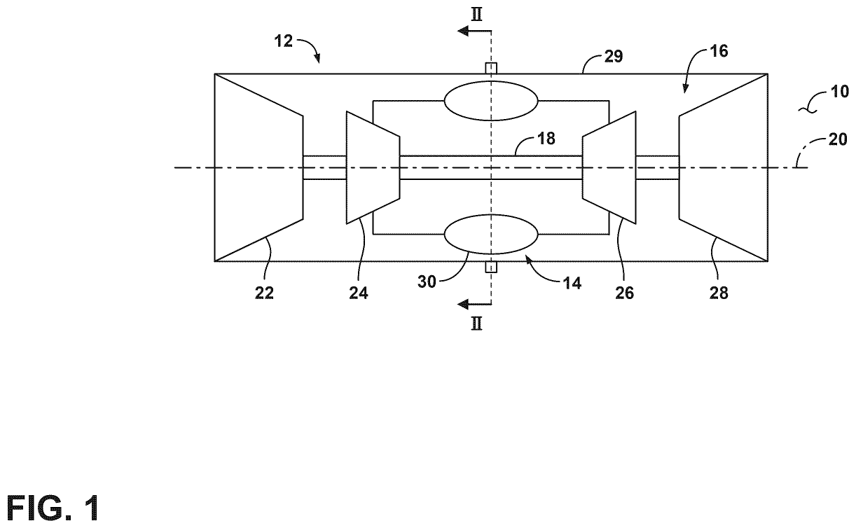

FIG. 1 is a schematic view of a turbine engine 10 (e.g., a gas turbine engine). As a non-limiting example, the turbine engine 10 can be used within an aircraft. The turbine engine 10 can include, at least, a compressor section 12, a combustion section 14, and a turbine section 16. A drive shaft 18 rotationally couples the compressor section 12 and turbine section 16, such that rotation of one affects the rotation of the other, and defines a rotational axis 20 for the turbine engine 10.

The compressor section 12 can include a low-pressure (LP) compressor 22, and a high-pressure (HP) compressor 24 serially fluidly coupled to one another. The turbine section 16 can include an HP turbine 26, and an LP turbine 28 serially fluidly coupled to one another. The drive shaft 18 can operatively couple the LP compressor 22, the HP compressor 24, the HP turbine 26 and the LP turbine 28 together. Alternatively, the drive shaft 18 can include an LP drive shaft and an HP drive shaft. The LP drive shaft can couple the LP compressor 22 to the LP turbine 28, and the HP drive shaft can couple the HP compressor 24 to the HP turbine 26. An LP spool can be defined as the combination of the LP compressor 22, the LP turbine 28, and the LP drive shaft such that the rotation of the LP turbine 28 can apply a driving force to the LP drive shaft, which in turn can rotate the LP compressor 22. An HP spool can be defined as the combination of the HP compressor 24, the HP turbine 26, and the HP drive shaft such that the rotation of the HP turbine 26 can apply a driving force to the HP drive shaft which in turn can rotate the HP compressor 24.

The compressor section 12 can include a plurality of axially spaced stages. Each stage includes a set of circumferentially-spaced rotating blades and a set of circumferentially-spaced stationary vanes. The compressor blades for a stage of the compressor section 12 can be mounted to a disk, which is mounted to the drive shaft 18. Each set of blades for a given stage can have its own disk. The vanes of the compressor section 12 can be mounted to a casing which can extend circumferentially about and enshroud one or more sections of the turbine engine 10. It will be appreciated that the representation of the compressor section 12 is merely schematic and that there can be any number of blades, vanes and stages. Further, it is contemplated that there can be any number of other components within the compressor section 12.

Similar to the compressor section 12, the turbine section 16 can include a plurality of axially spaced stages, with each stage having a set of circumferentially-spaced, rotating blades and a set of circumferentially-spaced, stationary vanes. The turbine blades for a stage of the turbine section 16 can be mounted to a disk which is mounted to the drive shaft 18. Each set of blades for a given stage can have its own disk. The vanes of the turbine section 16 can be mounted to the casing in a circumferential manner. It is noted that there can be any number of blades, vanes and turbine stages as the illustrated turbine section 16 is merely a schematic representation. Further, it is contemplated that there can be any number of other components within the turbine section 16.

The combustion section 14 can be provided serially between the compressor section 12 and the turbine section 16. The combustion section 14 can be fluidly coupled to at least a portion of the compressor section 12 and the turbine section 16 such that the combustion section 14 at least partially fluidly couples the compressor section 12 to the turbine section 16. As a non-limiting example, the combustion section 14 can be fluidly coupled to the HP compressor 24 at an upstream end of the combustion section 14 and to the HP turbine 26 at a downstream end of the combustion section 14.

During operation of the turbine engine 10, ambient or atmospheric air is drawn into the compressor section 12 via a fan upstream of the compressor section 12, where the air is compressed defining a pressurized air. The pressurized air can then flow into the combustion section 14 where the pressurized air is mixed with fuel and ignited, thereby generating combustion gases. Some work is extracted from these combustion gases by the HP turbine 26, which drives the HP compressor 24. The combustion gases are discharged into the LP turbine 28, which extracts additional work to drive the LP compressor 22, and the exhaust gas is ultimately discharged from the turbine engine 10 via an exhaust section downstream of the turbine section 16. The driving of the LP turbine 28 drives the LP spool to rotate the fan and the LP compressor 22. The pressurized air flow and the combustion gases can together define a working air flow that flows through the fan, compressor section 12, combustion section 14, and turbine section 16 of the turbine engine 10.

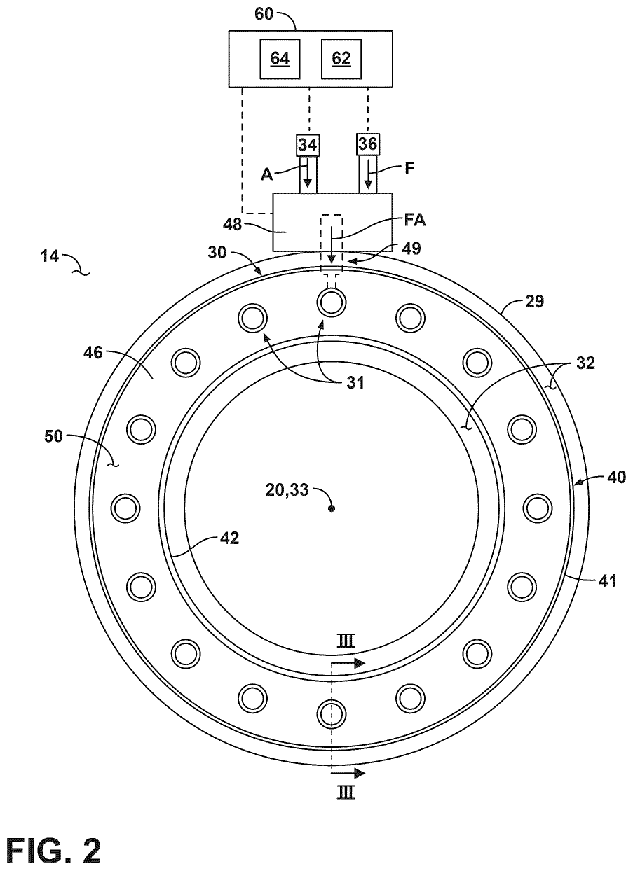

FIG. 2 depicts a cross-sectional view of the combustion section 14 along line II-II of FIG. 1. A centerline 33 of the combustion section 14 can be colinear with the rotational axis 20. The combustion section 14 can include a combustor 30. The combustor 30 can have a can, can-annular, or annular arrangement depending on the type of engine in which the combustor 30 is located. In a non-limiting example, the combustor 30 can have a combination arrangement located with a shroud or casing 29 of the turbine engine 10 (FIG. 1). The shroud or casing 29 can enshroud or cover at least a portion of the combustion section 14.

The combustor 30 can be at least partially defined by a combustor liner 40. In some examples, the combustor liner 40 can include an outer liner 41 and an inner liner 42 concentric with respect to each other and arranged in an annular fashion about the centerline 33 or rotational axis 20. In some examples, the combustor liner 40 can have an annular structure about the combustor 30. In some examples, the combustor liner 40 can include multiple segments or portions collectively forming the combustor liner 40. In some examples, the combustor liner 40 can include the outer liner 41 radially spaced from the inner liner 42. In some examples, the combustor liner 40 can include a single liner. A compressed air passage 32 can be defined at least in part by both the combustor liner 40 and the casing 29. The compressed air passage 32 can be fluidly coupled with the compressor section 12 (FIG. 1). The combustor liner 40 can also at least partially define a combustion chamber 50 arranged annularly about the rotational axis 20. For example, a wall 46 can be substantially perpendicular to the rotational axis 20 and can cooperate with the outer liner 41, the inner liner 42, or both, to at least partially define the combustion chamber 50. The term “substantially perpendicular” is defined as an angle equal to or between 85°and 95°. The combustor 30 can include an annular arrangement of combustor portions 31 disposed about the centerline 33 or rotational axis 20 of the turbine engine 10 (e.g., circumferentially spaced from each other in an annular configuration) (FIG. 1). The combustor portions 31 can be separately connected to the wall 46 and fluidly couple to the combustion chamber 50. The combustor portions 31 can be disposed at a radial distance from the centerline 33 that is greater than a radial distance of the inner liner 42 and less than a radial distance of the outer liner 41. The combustor portions 31 can, in some configurations, include or be combustor cups, fuel cups, or injector cups.

The combustion section 14 can also include a set of fuel mixer assemblies 48 fluidly coupled to the combustion chamber 50 by coupling to one of the combustor portions 31. While only one fuel mixer assembly in the set of fuel mixer assemblies 48 is shown, more than one can be provided where each fuel mixer assembly in the set of fuel mixer assemblies 48 can couple to a corresponding combustor portion 31.

By way of non-limiting example, a fuel mixer assembly in the set of fuel mixer assemblies 48 can include at least a mixing tube body 49 and a portion of the wall 46. In such a configuration, the portion of the wall 46 together with a portion of the mixing tube body 49 can define a mixing channel that supplies the fuel-air mixture to one or both of the combustor portions 31 and the combustion chamber 50.

The set of fuel mixer assemblies 48 can fluidly be coupled to an air source 34, a fuel source 36, or a combination thereof. The air source 34 can supply air (A) to the set of fuel mixer assemblies. The air source 34 can include or be fluidly coupled to the compressor section 12 (FIG. 1), the compressed air passage 32, or a combination thereof to provide compressed or pressurized air to the set of fuel mixer assemblies 48 during operation. It is contemplated that the air source 34 can provide more than one flow of air (A) to a fuel mixer assembly in the set of fuel mixer assemblies 48 that can vary in location within the fuel mixer assembly.

The fuel source 36 can supply fuel (F) to the set of fuel mixer assemblies 48. The fuel (F) supplied from the fuel source 36 can include any suitable liquid fuel, gaseous fuel, or a combination thereof. By way of example, the liquid or gaseous fuels can including one or more of hydrogen, natural gas, diesel, or Jet-A, and can optionally incorporate one or both of water and steam. With the combustors and fuel mixer assemblies described herein, the hydrogen-based fuel can be gaseous hydrogen fuel used without the need of diluents. In some examples, no diluent is added to the combustion chamber and the fuel is substantially completely diatomic hydrogen without diluent. As used herein, the term “substantially completely,” as used to describe the amount of a particular element or molecule (e.g., diatomic hydrogen), refers to at least 99% by mass of the described portion of the element or molecule, such as at least 97.5%, such as at least 95%, such as at least 92.5%, such as at least 90%, such as at least 85%, or such as at least 75% by mass of the described portion of the element or molecule. In an additional or alternative non-limiting example, fuel can be entirely (e.g., 100%) hydrogen by mass. In some examples, the fuel source 36, can provide more than one supply of fuel (F) to a fuel mixer assembly in the set of fuel mixer assemblies 48 that can vary in location, composition, temperature, pressure, flow rate, speed, phase (e.g., gas or liquid), or a combination thereof.

During operation of the turbine engine 10 (FIG. 1), a fuel mixer assembly in the set of fuel mixer assemblies 48 can receive air (A) provided by or drawn in from the air source 34 and fuel (F) provided from the fuel source 36. The fuel mixer assembly can mix together fuel (F) and air (A), at least to some degree (e.g., in mixing channel), to form a fuel-air mixture (FA) that can be supplied to the combustion chamber 50.

A controller 60 can be connected to and at least partially control operation of the fuel source 36, the air source 34, the set of fuel mixer assemblies 48, or a combination thereof. The controller 60 can include a processor 62 and a memory 64. In a non-limiting example, the controller 60 can utilize or increase flow from a particular supply of fuel (F) during takeoff or climb, which can require greater engine thrust, requiring a greater amount of fuel (F), while decreasing or ceasing a certain supply of fuel (F) as the operational conditions and requirements change during operation.

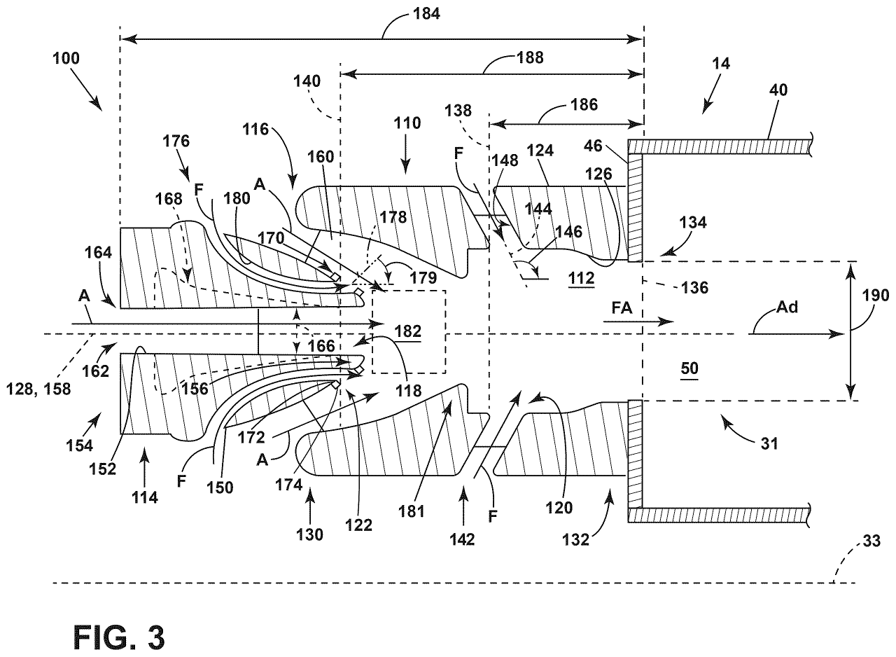

Turning to FIG. 3, a schematic cross-sectional view taken at the line III-III of FIG. 2 illustrates a fuel mixer assembly 100 suitable for use in the set of fuel mixer assemblies 48 (FIG. 2) according to an exemplary implementation.

The fuel mixer assembly 100 can include at least a mixing tube body 110, a portion of the wall 46, a mixing channel 112, a centerbody 114, a plurality of apertures 116, a centerbody air outlet 118, a first set of fuel orifices 120, and a second set of fuel orifices 122. The mixing tube body 110 can be similar to or utilized as the mixing tube body 49 (FIG. 2).

The mixing tube body 110 has a tube outer surface 124 and a tube inner surface 126. The tube inner surface 126 can at least partially define a hollow interior of the mixing tube body 110. A tube centerline 128 can be defined centrally within the mixing tube body 110. The tube centerline 128 can define an axial direction (Ad). In some examples, the tube centerline 128 can be parallel with and radially offset from the centerline 33 of the combustion section 14 (FIG. 2). The term “parallel” refers to generally parallel, where a line can be drawn across the tube centerline 128 and the centerline 33, wherein the line is in a range of 80° to 100° to both the tube centerline 128 and the centerline 33. The tube centerline 128 can be colinear with a centerline of the combustor portion 31 to which the fuel mixer assembly 100 is connected. The mixing tube body 110 can extend from a tube fore end 130 to a tube aft end 132. The tube aft end 132 can be the farthest point or end of the mixing tube body 110 extending downstream. One or more of the mixing tube body 110, the tube fore end 130, and the tube aft end 132 can have a circular cross-sectional shape about the tube centerline 128.

A portion of the wall 46 located at the tube aft end 132 can define a mixer outlet 134 configured to fluidly couple the mixing tube body 110 to the combustion chamber 50. Put another way, an inner surface of the mixer outlet 134 can align with the tube inner surface 126 at the tube aft end 132 to define an exit plane 136 where the mixer outlet 134 opens and provides fuel-air mixture (FA) to the combustion chamber 50.

The mixing channel 112 can be defined, at least in part, by the mixing tube body 110 and the wall 46. The mixing channel 112 can be fluidly coupled to the air source 34 (FIG. 2) and the fuel source 36 (FIG. 2). The mixing channel 112 is at least partially defined by the tube inner surface 126 and can extend from the mixer outlet 134 along the axial direction (Ad). The mixing channel 112 can extend in an aft-to-fore direction from the exit plane 136 of the mixer outlet 134 to a foremost point or an axial position where fuel (F) is supplied interior of the tube inner surface 126 to interact or initiate mixing with air (A). The fuel (F) can be supplied to the mixing channel 112 at one or more axial positions with respect to the tube centerline 128. In some examples, as shown herein, fuel (F) can be supplied at a first axial position 138 and at a second axial position 140, where the second axial position 140 is upstream of the first axial position 138. In such a configuration, the mixing channel 112 extends from the mixer outlet 134 to the second axial position 140.

A first set of fuel passages 142 can be at least partially defined by the mixing tube body 110 and can be configured to supply fuel (F) to the mixing channel 112 at the first axial position 138. Put another way, the first set of fuel passages 142 can extend through the mixing tube body 110 between the tube outer surface 124 and the tube inner surface 126. The first set of fuel passages 142 can terminate at the first set of fuel orifices 120 defined in the tube inner surface 126 at the first axial position 138. As such, the first set of fuel passages 142 together with the first set of fuel orifices 120 can fluidly couple the fuel source 36 (FIG. 2) to the mixing channel 112 to supply fuel (F) to the mixing channel 112 at the first axial position 138. In a non-limiting example, the first set of fuel orifices 120 can be circumferentially spaced from each other in an annular configuration about the tube centerline 128.

A first fuel orifice axis 144 can be defined centrally in each orifice in the first set of fuel orifices 120. A first fuel angle 146 can be defined as the angle between the first fuel orifice axis 144 and the tube centerline 128. In some examples, the first fuel angle 146 can be greater than or equal to 10° and less than or equal to 140° (e.g., 0° being parallel to the tube centerline 128). As such, the first set of fuel orifices 120 can emit fuel (F) in a direction that is offset from parallel to the tube centerline 128. Such an offset can impart swirl in the fuel (F) provided from the first set of fuel orifices 120 to the mixing channel 112 and form a swirled fuel stream.

Additionally or alternatively, fuel (F) flowing in the first set of fuel passages 142 can be angled with respect to a central axis of a fuel passage in the first set of fuel passages 142. As such, an inner radial surface 148 of the first set of fuel passages 142 can deflect fuel (F) and impart swirl in fuel (F) provided to the mixing channel 112 to form a swirled fuel stream. Benefits of such configurations can include but are not limited to improved mixing of the fuel and air and more uniform fuel distribution in formed fuel-air mixture (FA).

The centerbody 114 can be at least partially circumscribed by the mixing tube body 110. The centerbody 114 can have a centerbody outer surface 150 and a centerbody inner surface 152. The centerbody 114 can be at least partially hollow. The centerbody 114 can extend from a centerbody fore end 154 to an aft end, or a centerbody axial end 156. As illustrated herein, a centerbody centerline 158 defined centrally within the centerbody 114 can be, in some examples, colinear with the tube centerline 128. In another non-limiting example the tube centerline 128 and the centerbody centerline 158 can be offset or intersect to form a non-zero angle.

The centerbody 114 can extend outside the mixing tube body 110 such that the centerbody fore end 154 is upstream of the tube fore end 130. The centerbody axial end 156 can be the farthest point or end of the centerbody 114 extending downstream into the mixing channel 112, where the centerbody axial end 156 is circumscribed by the mixing tube body 110.

A portion of the centerbody 114 can couple to a portion of the mixing tube body 110 at or adjacent to the tube fore end 130. The centerbody 114 together with the mixing tube body 110 can define the plurality of apertures 116 circumferentially spaced about the tube centerline 128. That is, the plurality of apertures 116 can be at or adjacent to the tube fore end 130. The plurality of apertures 116 can be fluidly coupled to the air source 34 (FIG. 2).

Downstream of the plurality of apertures 116, the centerbody 114 can be spaced from the tube inner surface 126. Put another way, the mixing tube body 110 can circumscribe the centerbody 114 such that the tube inner surface 126 can be radially spaced from the centerbody outer surface 150. As such, a hollow annulus or annular flow passage 160 can be defined between the tube inner surface 126 and centerbody outer surface 150. The annular flow passage 160 can fluidly couple the plurality of apertures 116 and the mixing channel 112. As such, during operation, the plurality of apertures 116 can receive air (A) from the air source 34 (FIG. 2) that flows through the annular flow passage 160 to be supplied to the mixing channel 112. In some examples, the plurality of apertures 116 can provide 40% to 95% of a total amount of air provided to the mixing channel 112. Such a configuration can increase the penetration of fuel (F) into air (A) flowing in the mixing channel 112 from the plurality of apertures 116 that can facilitate mixing of fuel (F) and air (A) to form a more uniform fuel-air mixture (FA).

The centerbody inner surface 152 can define a centerbody air passage 162. The centerbody air passage 162 can extend from a centerbody air inlet 164 located at or adjacent to the centerbody fore end 154 and terminate at the centerbody air outlet 118 located at or adjacent to the centerbody axial end 156. The centerbody air inlet 164 and the centerbody air outlet 118 can be defined in the centerbody outer surface 150. The centerbody air passage 162 together with the centerbody air inlet 164 and the centerbody air outlet 118 can fluidly couple the air source 34 (FIG. 2) to the mixing channel 112. As such, during operation, the centerbody air passage 162 can receive air (A) from the air source 34 (FIG. 2) at the centerbody air inlet 164 and provide the air (A) to the mixing channel 112 from the centerbody air outlet 118. In some examples, the centerbody air passage 162 can provide 5% to 60% of a total amount of air provided to the mixing channel 112. Such a configuration can increase the penetration of fuel (F) into air (A) flowing in the mixing channel 112 from the centerbody air outlet 118 that can facilitate mixing of fuel (F) and air (A) to form a more uniform fuel-air mixture (FA).

Inner dimensions 166 (e.g., hydraulic diameter) of the centerbody air passage 162 can be measured perpendicular to the centerbody centerline 158. The inner dimensions 166 can be constant between the centerbody air inlet 164 and the centerbody air outlet 118. That is, air (A) provided from the centerbody air outlet 118 can have no swirl.

Dotted lines 168 illustrate, by way of non-limiting example, an optional configuration of the centerbody air passage 162 where inner dimensions 166 can vary in one or more portions of the centerbody air passage 162. In some examples, during operation, air (A) received in the centerbody air inlet 164 can deflect off the centerbody inner surface 152 and can, to some degree, impart swirl in air (A) provided to the mixing channel 112.

A set of fuel posts 170 can be located on or at least partially formed by the centerbody outer surface 150. The set of fuel posts 170 can be spaced about a central axis of the centerbody air outlet 118. The set of fuel posts 170 can extend radially outward from the centerbody outer surface 150 and toward the tube inner surface 126. The set of fuel posts 170 can extend from a fuel post base 172 located at the centerbody outer surface 150 to a fuel post tip 174.

The set of fuel posts 170, together with the centerbody 114, can at least partially define a second set of fuel passages 176. As such, a fuel passage in the second set of fuel passages 176 can extend through the centerbody 114 and terminate at a corresponding fuel orifice in the second set of fuel orifices 122 defined in the fuel post tip 174. The second set of fuel passages 176 can fluidly couple the fuel source 36 (FIG. 2) and the mixing channel 112 to provide fuel (F) to the mixing channel 112 from the second set of fuel orifices located at the second axial position 140.

A second fuel orifice axis 178 can be defined centrally in each orifice in the second set of fuel orifices 120. A second fuel angle 179 can be defined as the angle between the second fuel orifice axis 178 and the tube centerline 128. In some examples, the second fuel angle 179 can be greater than or equal to 0° and less than or equal to 60° (e.g., 0° being parallel to the tube centerline 128). As such, the second set of fuel orifices 122 can emit fuel (F) in a direction that is offset from parallel to the tube centerline 128. Such an offset can impart swirl in the fuel (F) provided from the second set of fuel orifices 122 to the mixing channel 112. Additionally or alternatively, fuel (F) flowing in the second set of fuel passages 176 can be angled with respect to a central axis of a fuel passage in the second set of fuel passages 176. As such, an inner radial surface 180 of the second set of fuel passages 176 can deflect fuel (F) and can impart swirl in fuel (F) provided to the mixing channel 112. Benefits of such configurations can include but are not limited to improved mixing of the fuel and air and more uniform fuel distribution in formed fuel-air mixture (FA).

During operation, a high shear zone 182 can be formed in the mixing channel 112 where a combination of air (A) supplied from the plurality of apertures 116 and air (A) supplied from the centerbody air outlet 118 straddles fuel (F) entering from the second set of fuel orifices 122. Put another way, air (A) supplied from the centerbody air outlet 118 can form a first air stream and air (A) supplied from the plurality of apertures 116 can form a second air stream that passes over the centerbody outer surface 150. The fuel (F) entering from a fuel orifice in the second set of fuel orifices 122 is supplied between the first air stream and the second air stream. As such, the first air stream and the second air stream can promote rapid mixing and high momentum in the fuel (F), especially low density fuel. Benefits further include improved fuel (F) and air (A) mixing that can reduce NOx emissions and improve flame stability of a resulting fuel-air mixture (FA). While illustrated as a dotted rectangle, the high shear zone 182 can have any shape that encompasses a three dimensional portion of the mixing channel 112 where an annular configuration of the plurality of apertures 116 about the tube centerline 128 and the centerbody air outlet 118 straddles an annular configuration of the second set of fuel orifices 122. Benefits of such a configuration include improved toroidal stabilization of the fuel-air mixture (FA) and greater flame stability.

Optionally, the fuel mixer assembly 100 can include a set of turbulators 181. The set of turbulators 181 can include protrusions defined in the tube inner surface 126 that extend into the mixing channel 112. As such, the set of turbulators 181 can impart turbulence in air (A), fuel (F), or a combination thereof in the mixing channel 112. The set of turbulators 181 can, for example, be located downstream of the first set of fuel orifices 120, the second set of fuel orifices 122, or a combination thereof. Put another way, the set of turbulators 181 can be downstream of where fuel (F) is supplied to the mixing channel 112 to interact and promote mixing of the fuel (F) in the mixing channel 112. Additionally, or alternatively, the set of turbulators 181 can be located axially along the tube inner surface 126 between the first set of fuel orifices 120 and the second set of fuel orifices 122, as shown. One or more of the turbulators in the set of turbulators 181 can be vortex generators. Vortex generators can include one or more of a variety of configurations, such as counter-rotating, delta wing, double-sided wedge, wheeler, wing, winglet, Kuethe, wishbone, hairpin, lobed, wave-type, or any combination thereof.

As used herein, “total mixer length” refers to a total length of the fuel mixer assembly 100 (e.g., including centerbody 114, mixing tube body 110, and the portion of the wall 46 forming the mixer outlet 134, i.e., at the exit plane 136). The term, “mixing length” can be defined for a portion of the mixing tube body 110 in which air (A) and fuel (F) are mixed. A total mixer length 184 can be measured axially from a position along the mixer outlet 134 at the exit plane 136. A first mixing length 186 can be measured axially from the first set of fuel orifices 120 to the exit plane 136. A second mixing length 188 can be measured axially from the second set of fuel orifices 122 to the exit plane 136.

In some examples, the first mixing length 186 can be greater than or equal to 10% and less than or equal to 75% of the second mixing length 188. In some examples, the second mixing length 188 can be greater than or equal to 60% and less than or equal to 95% of the total mixer length 184.

An exit diameter 190 can be measured as a hydraulic diameter of the mixer outlet 134 at the exit plane 136, and will be used to discuss additional elements, including configurations of the second set of fuel orifices 122 below.

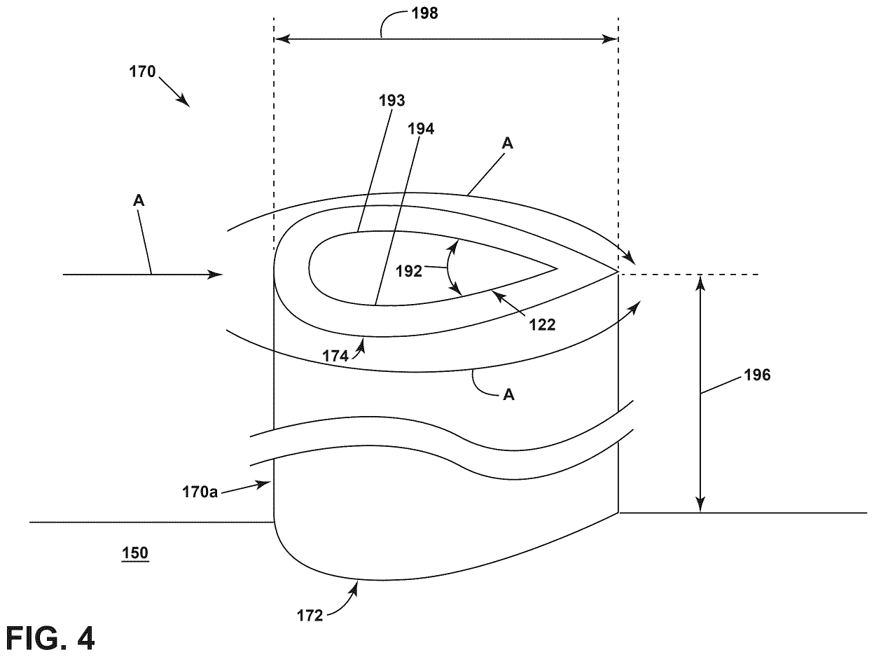

FIG. 4 illustrates an exemplary fuel post 170a that can be utilized in the set of fuel posts 170. The fuel post 170a extends from the centerbody outer surface 150 to a fuel post tip 174. The fuel post 170a can, in some examples, be airfoil shaped, as shown. The corresponding fuel orifice in the set of fuel orifices 122 can be airfoil shaped or define an orifice angle 192 greater than or equal to 0° (e.g., 0° being a rectangular orifice) and less than or equal to 180° (e.g., 180° being a circular orifice), where the orifice angle 192 can be measured between an upper line or camber line 193 and lower line or camber line 194 of the corresponding fuel orifice in the set of fuel orifices 122.

A fuel post extension distance 196 can be measured from the fuel post base 172 to the fuel post tip 174. The fuel post extension distance 196 can be greater than 0% and less than or equal to 50% of the exit diameter 190 (FIG. 3). A fuel post length 198 can be measured between upstream and downstream ends along the fuel post tip 174 along the centerbody outer surface 150. The fuel post length 198 can be greater than 0% and less than or equal to 20% a diameter of the exit diameter 190 (FIG. 3). In some examples, such as the fuel post 170a illustrated, fuel posts in the set of fuel posts 170 can be aligned to a direction of incoming air (A) from the plurality of apertures 116. In another non-limiting example, when air (A) flowing from the plurality of apertures is swirled air (A), fuel posts in the set of fuel posts 170 can be aligned to a direction of the incoming swirled air (A).

The fuel post 170a can affect the air (A) flowing from the plurality of apertures 116 and into the mixing channel 112. In some examples, the set of fuel posts 170 that radially extend from the centerbody outer surface 150 can at least partially obstruct air (A) flowing through the annular flow passage 160. As such, a portion of air (A) flowing from the plurality of apertures 116 to the mixing channel 112 can be impinged or split by the fuel post 170a, as indicated by arrows. This impinging of air (A) can introduce turbulations or add additional vorticity (e.g., cross-wise perturbations or oscillations) within air (A) that can improve fuel (F) penetration and mixing in the mixing channel 112.

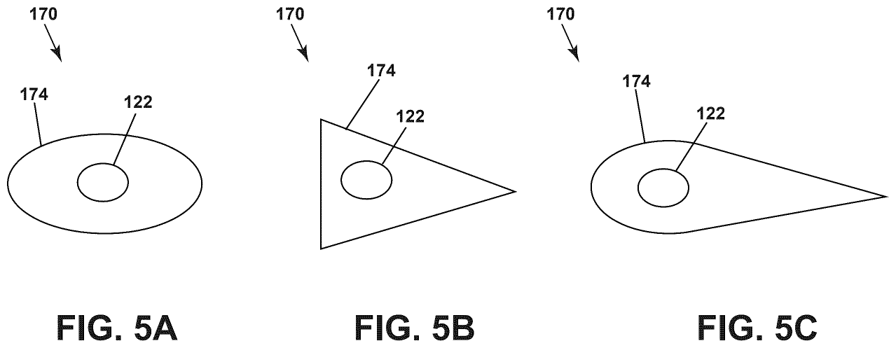

FIG. 5A, FIG. 5B, and FIG. 5C are schematic views of example cross-sections of the set of fuel posts 170. A fuel post in the set of fuel posts 170 can at least partially be defined by a variety of shapes including that of an arcuate shape (elliptical, circular, or oval) (FIG. 5A), a triangular shape (FIG. 5B), an airfoil shape (FIG. 5C), or include a combination thereof. Some shapes can, to a varying degree, turbulate emitted air (A) and, in turn, facilitate the mixing of air (A) and fuel (F) (FIG. 3) entering the mixing channel 112 (FIG. 3). Benefits of such configurations can include lower flame temperatures, and lower flashback or flame holding capability. Some shapes can be less complex to manufacture via drilling, such as circular shapes. Additionally or alternatively, some shapes can be less complex to manufacture via additive manufacturing, such as triangular shapes. Further, some shapes can increase aerodynamic performance, such as airfoil shapes.

While fuel orifices in the second set of fuel orifices 122 in FIGS. 5A-5C are illustrated as having an arcuate shape (elliptical, circular, oval), it is contemplated that a cross-sectional shape of a fuel orifice in the second set of fuel orifices 122 can include a variety of shapes, including a rectangular shape, a triangular shape, an airfoil shape, or include combinations of arcuate, triangular, or airfoil shapes. In some examples, cross-sectional shapes of a fuel orifice in the second set of fuel orifices 122 and a corresponding fuel post in the set of fuel posts 170 can be the same, such as in FIG. 4, where an airfoil shaped fuel orifice and airfoil shaped fuel post is illustrated, or in FIG. 5A, where an arcuate shaped fuel orifice and an arcuate shaped fuel post is illustrated. In a different and non-limiting example, cross-sectional shapes of a fuel orifice in the second set of fuel orifices 122 and a corresponding fuel post in the set of fuel posts 170 can be different (FIGS. 5B-5C).

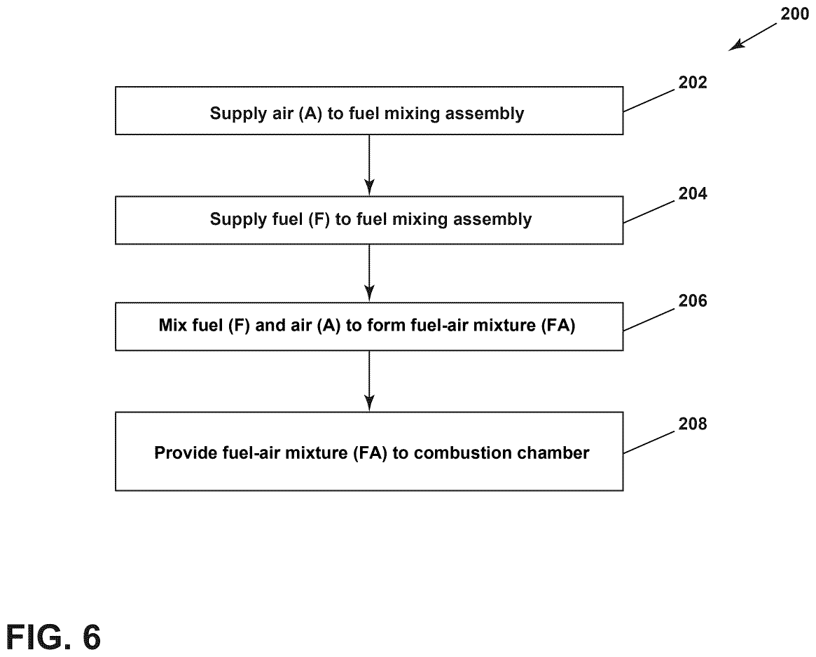

Referring to FIG. 6, a method 200 of operating a turbine engine (e.g., the turbine engine 10 of FIG. 1) of FIGS. 2-6, is provided. At step 202, air (A) can be supplied from the air source 34 and provided to the fuel mixer assembly 100. In operation, air (A) from the air source 34 can be provided to or drawn in by the plurality of apertures 116 and the centerbody air outlet 118. As such, at least two streams of air (A) can be provided to the mixing channel 112. The at least two air streams include a first air stream passing through the centerbody 114 and a second air stream passing over the centerbody 114. That is, the first air stream of the at least two air streams can pass through the centerbody air passage 162 and the second air stream of the at least two air streams can be provided by the plurality of apertures 116 along the centerbody outer surface 150. The air (A) provided from one of the plurality of apertures 116 and the centerbody air outlet 118 can be a swirled air stream. The stream of swirled air (A) from one or both of the plurality of apertures 116 and the centerbody air outlet 118 can have a swirl number greater than or equal to 0 and less than or equal to 0.4. Optionally, both of the plurality of apertures 116 and the centerbody air outlet 118 can provide a stream of swirled air (A). As such, the two streams of swirled air (A) can be co swirled or counter swirled air streams.

At step 204, fuel (F) can be supplied from the fuel source 36 and provided to the fuel mixer assembly 100. During low power conditions, fuel (F) can be supplied to the first set of fuel passages 142 and provided to the mixing channel 112 at the first axial position 138. During high power conditions, fuel (F) can be supplied to the second set of fuel passages 176 and provided to the mixing channel 112 at the second axial position 140. In some examples when transitioning between low power conditions and high power conditions (e.g., when the turbine engine 10 needs to switch from cruising to climb), fuel (F) can be supplied to the mixing channel 112 at both the first axial position 138 and the second axial position 140.

At step 206, air (A) and fuel (F) can be mixed in the mixing channel 112. At step 208, the fuel and air mixture (FA) can be provided to the combustion chamber 50. That is, the fuel and air mixture (FA) can be ignited to generate power or produce propulsive thrust in the engine.

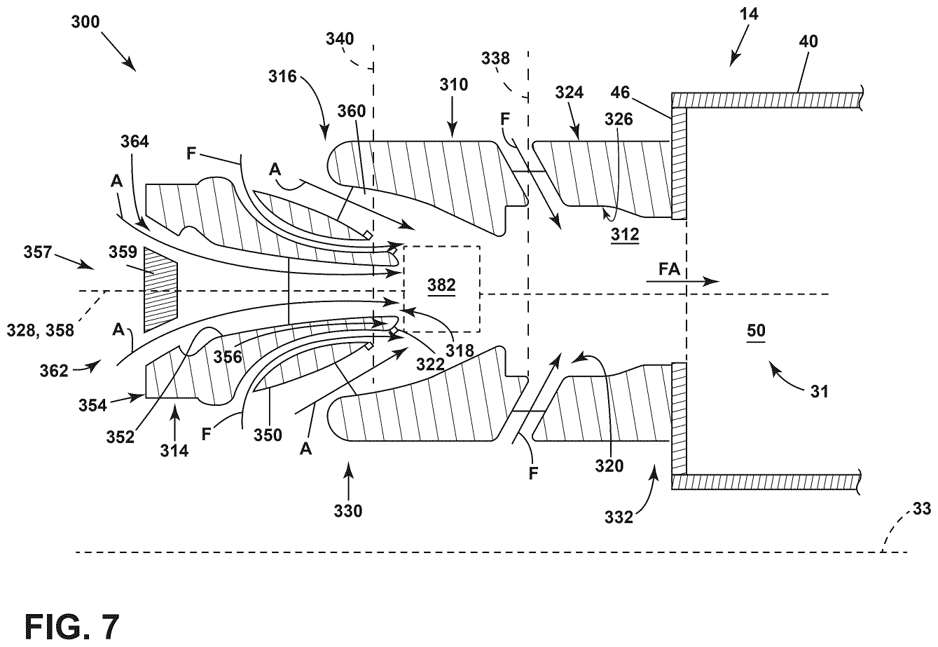

FIG. 7 illustrates a fuel mixer assembly 300 similar to the fuel mixer assembly 100 of FIG. 3. Therefore, like parts will be identified with like numerals increased to the 300-series with it being understood that the description of the fuel mixer assembly 100 (FIG. 3) can apply to the fuel mixer assembly 300 unless noted otherwise.

The fuel mixer assembly 300 can include at least a mixing tube body 310, a portion of the wall 46, a mixing channel 312, a centerbody 314, a plurality of apertures 316, a centerbody air outlet 318, a first set of fuel orifices 320, and a second set of fuel orifices 322.

The mixing tube body 310 has a tube outer surface 324 and a tube inner surface 326, where a tube centerline 328 can be defined centrally within the mixing tube body 310. The mixing tube body 110 extends from a tube fore end 330 to a tube aft end 332. The mixing channel 312 can be defined, at least in part, by the mixing tube body 310 and the wall 46. The fuel (F) can be supplied to the mixing channel 312 at a first axial position 338 and at a second axial position 340. A high shear zone 382 can be formed in the mixing channel 312 and be similar to the high shear zone 182 of FIG. 3.

The centerbody 314 can be at least partially circumscribed by the mixing tube body 310 and extends from a centerbody fore end 354 to a centerbody axial end 356. The centerbody 314 can have a centerbody outer surface 350 and a centerbody inner surface 352. A centerbody centerline 358 can be defined centrally within the centerbody 314. A hollow annulus or annular flow passage 360 can be defined between the tube inner surface 326 and centerbody outer surface 350.

The centerbody inner surface 352 can define a centerbody air passage 362 that extends between a centerbody air inlet 364 and the centerbody air outlet 318. The centerbody air passage 362 together with the centerbody air inlet 364 and the centerbody air outlet 318 can fluidly couple the air source 34 (FIG. 2) to the mixing channel 312.

The centerbody 314 can include or have a swirler 357 located at the centerbody fore end 354. The swirler 357 can include a set of swirler vanes 359 that partially obstruct the centerbody air inlet 364 and can impart swirl on air (A) entering the centerbody air inlet 364. As such, swirled air (A) can flow through the centerbody air passage 362 and be provided to the mixing channel 112. The swirled air (A) can have a swirl number greater than or equal to 0 and less than or equal to 0.4. Benefits of such a configuration include improved fuel (F) and air (A) mixing that can reduce NOx emissions and improve flame stability of a resulting fuel-air mixture (FA).

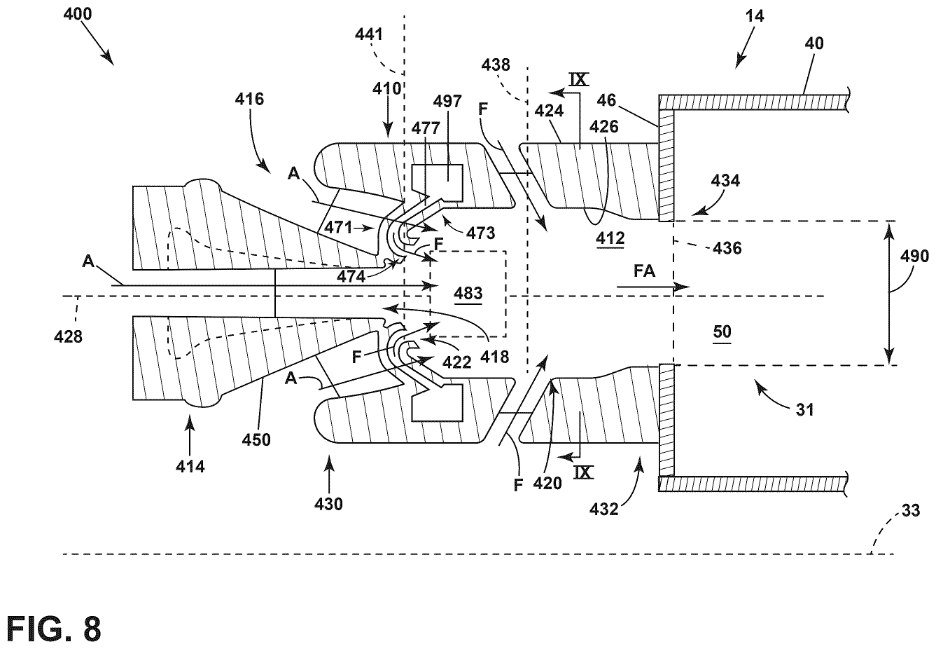

FIG. 8 illustrates a fuel mixer assembly 400 similar to the fuel mixer assembly 100 of FIG. 3. Therefore, like parts will be identified with like numerals increased to the 400-series with it being understood that the description of the fuel mixer assembly 100 (FIG. 3) can apply to the fuel mixer assembly 400 unless noted otherwise.

The fuel mixer assembly 400 can include at least a mixing tube body 410, a portion of the wall 46, a mixing channel 412, a centerbody 414, a plurality of apertures 416, a centerbody air outlet 418, a first set of fuel orifices 420, and a second set of fuel orifices 422. A tube centerline 428 can be defined centrally within the mixing tube body 410. The mixing tube body 410 has a tube outer surface 424 and a tube inner surface 426. The mixing tube body 410 can extend from a tube fore end 430 to a tube aft end 432. The portion of the wall 46 located at the tube aft end 432 can define a mixer outlet 434 and an exit plane 436 where the mixer outlet 434 opens and provides fuel-air mixture (FA) to the combustion chamber 50. The centerbody 414 can have a centerbody outer surface 450.

The mixing channel 412 can receive fuel (F) at a first axial position 438 and at a second axial position 441 with respect to the tube centerline 428. The second axial position 441 is upstream of the first axial position 438.

The set of fuel posts 471 can be located on or at least partially formed by the mixing tube body 410. The set of fuel posts 471 can radially extend from the tube outer surface 424 and at least partially obstruct air (A) flowing from the plurality of apertures 416 to the mixing channel 412. Each fuel post in the set of fuel posts 471 can extend from a fuel post base 473 located at the tube inner surface 426 to a fuel post tip 474. It is contemplated that the fuel post tip Each fuel post tip 474 can define a fuel orifice in the second set of fuel orifices 422.

The second set of fuel orifices 422 can be located at the second axial position 441. By way of non-limiting example, each fuel post of the set of fuel posts 471 can extend from the fuel post base 473 located at the tube inner surface 426 in an upstream direction, then curve or bend such that the fuel post tip 474 opens in a downstream direction.

The set of fuel posts 471 together with the mixing tube body 410 can define a second set of fuel passages 477. As such, a fuel passage in the second set of fuel passages 477 can extend through the centerbody 414 and terminate at a corresponding fuel orifice in the second set of fuel orifices 422. The second set of fuel passages 477 can fluidly couple the fuel source 36 (FIG. 2) to the mixing channel 412 and can provide fuel (F) to the mixing channel 412 from the second set of fuel orifices 422 at the second axial position 441.

During operation, a high shear zone 483 can be formed in the mixing channel 412 where a combination of air (A) provided from the plurality of apertures 416 and air (A) supplied from the centerbody air outlet 418 straddles fuel (F) entering from the second set of fuel orifices 422. As such, the high shear zone 483 can promote rapid mixing and high momentum in the fuel (F) and, in turn, the fuel-air mixture (FA). While illustrated as a dotted rectangle, the high shear zone 483 can have any shape that encompasses a three dimensional portion of the mixing channel 412 where an annular configuration of the plurality of apertures 416 about the tube centerline 428 and the centerbody air outlet 418 straddles an annular configuration of the second set of fuel orifices 422. Benefits of such a configuration include improved toroidal stabilization of the fuel-air mixture (FA) and greater flame stability.

An exit diameter 490 can be measured as a hydraulic diameter of the mixer outlet 434 at the exit plane 436. A fuel post extension distance is measured similar to the fuel post extension distance 196 (FIG. 4) and can be measured from the fuel post base 473 to the fuel post tip 474. The fuel post extension distance can be greater than 5% and less than or equal to 10% of the exit diameter 490. As such, the set of fuel posts 471 can be provided to supply fuel (F) within the mixing channel 412 at a variety of radial locations about the tube centerline 428. Benefits include increased penetration of fuel (F) into air (A) flowing in the mixing channel 412 and improved mixing of fuel (F) and air (A) to form a more uniform fuel-air mixture (FA). While the fuel post extension distance of each fuel post in the set of fuel posts 471 is illustrated as being the same, one or more fuel posts can have different the fuel post extension distances. Optionally, the set of fuel posts 471 can be inwardly cut relative to the tube centerline 428.

The set of fuel posts 471, together with the second set of fuel orifices 422, are illustrated, by way of example, as extending into the mixing channel 412 with the second set of fuel orifices 422 facing the tube centerline 428. Put another way, fuel (F) provided to the mixing channel 412 from the second set of fuel orifices 422 can be directed towards the tube centerline 428. Such a configuration can increase the penetration of fuel (F) into air (A) flowing in the mixing channel 412 from the plurality of apertures 416, the centerbody air outlet 418, or a combination thereof which can facilitate mixing of fuel (F) and air (A) to form a more uniform fuel-air mixture (FA).

Optionally, the fuel mixer assembly 400 can include a fuel manifold 497 fluidly coupling the fuel source 36 and the second set of fuel passages 477. The fuel manifold 497 can be at least partially defined in the mixing tube body 410, as shown, and have an annular configuration about the tube centerline 428.

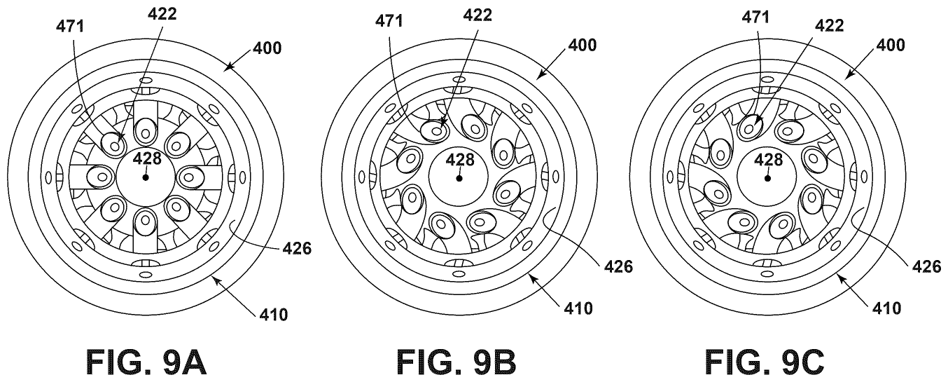

FIG. 9A illustrates a schematic cross-sectional view of the fuel mixer assembly 400 taken at the line IX-IX in FIG. 8 in one exemplary implementation. The set of fuel posts 471 can be extend radially inward with respect to the tube centerline 428. It is contemplated that one or more fuel posts in the set of fuel posts 471 can extend between the tube inner surface 426 to the tube centerline 428 at varying distances. In some examples, a profile of the set of fuel posts 471 extending between the tube inner surface 426 to the tube centerline 428 can be linear when viewed from a cross-section, such as the cross-section shown in FIG. 9A. In a different and non-limiting example, it is contemplated that the profile of the set of fuel posts 471 extending between the tube inner surface 426 to the tube centerline 428 can be curved. Such a configuration can swirl fuel (F) exiting a fuel orifice in the second set of fuel orifices 122. Benefits include improved fuel (F) penetration into air (A) that can minimize pockets of fuel along the tube inner surface 426 and improved mixing of the fuel (F) and air (A).

FIG. 9B and FIG. 9C illustrate the schematic cross-sectional view of the fuel mixer assembly 400 taken at the line IX-IX in FIG. 8 according to two other exemplary configurations. In some examples, as shown, the second set of fuel orifices 422 can be oriented radially outward with respect to the tube centerline 128. That is, the second set of fuel orifices 422 can be oriented to supply fuel (F) away from the tube centerline 128 (e.g., toward the tube inner surface 426). While illustrated as being in a clockwise orientation in FIG. 9B, the set of fuel posts 471 can extend from the tube inner surface 426 to the tube centerline 428 in a counterclockwise orientation (FIG. 9C). Such a configuration can promote fuel (F) and air (A) mixing by providing a wider dispersion of fuel (F) in the mixing channel 112. Improved mixing can facilitate forming a more uniform fuel-air mixture (FA), improve flame stability, and reduce NOₓ emissions.

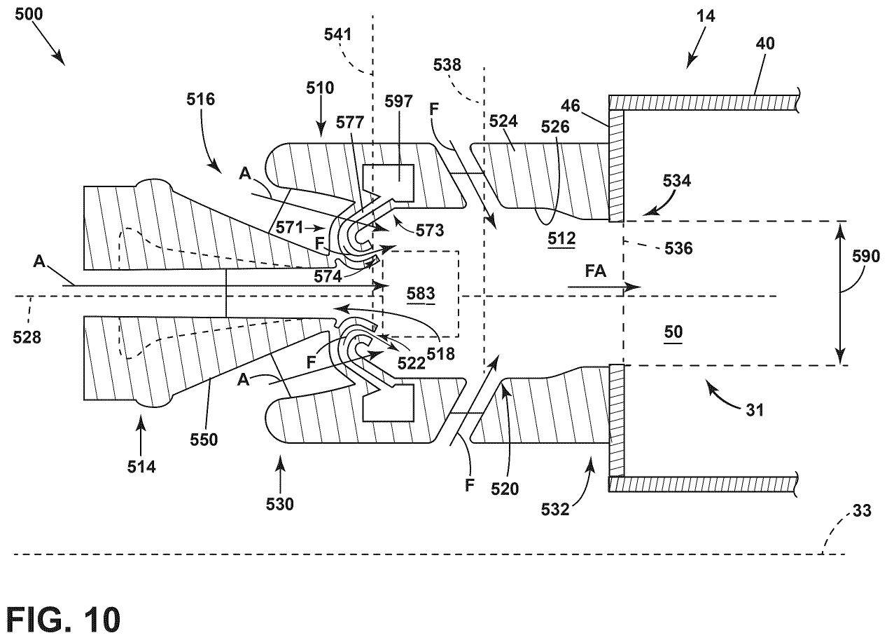

FIG. 10 illustrates a fuel mixer assembly 500 similar to the fuel mixer assembly 400 of FIG. 8. Therefore, like parts will be identified with like numerals increased to the 500-series with it being understood that the description of the fuel mixer assembly 500 (FIG. 3) can apply to the fuel mixer assembly 400 unless noted otherwise.

The fuel mixer assembly 500 can include at least a mixing tube body 510, a portion of the wall 46, a mixing channel 512, a centerbody 514, a plurality of apertures 516, a centerbody air outlet 518, a first set of fuel orifices 520, and a second set of fuel orifices 522. A tube centerline 528 can be defined centrally within the mixing tube body 510. The mixing tube body 510 has a tube outer surface 524 and a tube inner surface 526. The mixing tube body 510 can extend from a tube fore end 530 to a tube aft end 532. The portion of the wall 46 located at the tube aft end 532 can define a mixer outlet 534 and an exit plane 536 where the mixer outlet 534 opens and provides fuel-air mixture (FA) to the combustion chamber 50. An exit diameter 590 can be measured as a hydraulic diameter of the mixer outlet 534 at the exit plane 536. The centerbody 514 can have a centerbody outer surface 550.

The mixing channel 512 can receive fuel (F) at a first axial position 538 from the first set of fuel orifices 520 defined in the mixing tube body 510. The mixing channel 512 can receive fuel (F) at a second axial position 541 from the second set of fuel orifices 522 defined by a set of fuel posts 571, where the second axial position 541 is downstream of the first axial position 538. A high shear zone 583 can be formed in the mixing channel 512 and be similar to the high shear zone 483 of FIG. 8.

The set of fuel posts 571 can be located on or at least partially formed by the mixing tube body 510. The set of fuel posts 571 can radially extend from the tube outer surface 524 and at least partially obstruct air (A) flowing from the plurality of apertures 516 to the mixing channel 512. Each fuel post in the set of fuel posts 571 can extend from a fuel post base 573 located at the tube inner surface 526 to a fuel post tip 574. Each fuel post tip 574 can define a fuel orifice in the second set of fuel orifices 522. The second set of fuel orifices 522 can be located at the second axial position 541.

The set of fuel posts 571, together with the second set of fuel orifices 522, are illustrated, by way of example, as extending into the mixing channel 512 with the second set of fuel orifices 522 facing away from the tube centerline 528. Put another way, fuel (F) provided to the mixing channel 512 from the second set of fuel orifices 522 can be directed away from the tube centerline 528 or towards a tube inner surface 526 of the mixing tube body 510. Such a configuration can widen the distribution of fuel (F) in the mixing channel 512 and limit richer pockets of fuel (F) to provide greater flame stability.

Optionally, the fuel mixer assembly 500 includes a fuel manifold 597 similar to the fuel manifold 497 of FIG. 8 and can fluidly couple the fuel source 36 and the second set of fuel passages 577.

In some examples, the disclosed combustors and fuel mixer assemblies can be utilized with gaseous fuel, such as hydrogen, utilized with traditional fuel, such as kerosine (e.g., Jet A), diesel, natural gas, methane, ammonia, combinations of traditional fuels, or combinations of hydrogen and one or more traditional fuels. Gaseous fuel, including hydrogen, spreads or disperses at a faster rate than atomized traditional fuel, which can involve less mixing time for the gaseous fuel, mixing tube lengths can be shorter, and the flame from the gaseous fuel can be more likely to spread farther and faster, which can increase the risk of blowout and increase the impact of controlling the flame and limiting flame spread by controlling the dispersion of the gaseous fuel.

Many other possible aspects and configurations in addition to those shown in the above figures are contemplated by the present disclosure. For example, the disclosed fuel mixer assemblies can provide greater flame stability, lower flame temperatures, and lower NOx emissions relative to other designs.

Fuel mixer assemblies disclosed herein can include fuel (F) supplied from a fuel source to a mixing channel at one or more locations in the fuel mixer assembly, where a downstream portion of the fuel mixer assembly is operational during low power conditions and an upstream portion of upstream is operational during high power conditions. As such, operation of the fuel mixer assembly as a whole can have better flame stability during low power conditions, and low NOₓ emissions. The upstream portion of the fuel supply can include fuel posts partially obstructing and imparting turbulence on incoming air. Such a configuration can improve mixing of the fuel and air and provide a uniform fuel distribution in a resulting fuel-air mixture, The fuel posts, as disclosed herein, can extend a distance in one or both of an axial direction (Ad) and a radial direction (Rd) (e.g., towards a mixing channel centerline), and can curve or bend to supply a radial distribution of fuel (F) into the mixing channel that can improve fuel penetration into air and thus, improve uniform fuel distribution, flame stability, and reduce NOₓ emissions. Turbulators that extend into the mixing channel of the fuel mixer assembly can create turbulence for improving mixing of fuel and air.

While described with respect to a turbine engine, it should be appreciated that the combustor as described herein can be for any engine with a having a combustor. It should be appreciated that application of aspects of the disclosure discussed herein are applicable to engines with propeller sections or fan and booster sections along with turbojets and turbo engines as well.

To the extent not already described, the different features and structures of the various embodiments can be used in combination, or in substitution with each other as desired. That one feature is not illustrated in all the embodiments is not meant to be construed that it cannot be so illustrated but is done for brevity of description. Thus, the various features of the different embodiments can be mixed and matched as desired to form new embodiments, whether or not the new embodiments are expressly described. All combinations or permutations of features described herein are covered by this disclosure. For example, and without limitation, combustors can include various combinations of fuel mixer assemblies. In some examples, the same combustor can include fuel mixer assemblies with any combination of the configurations illustrated in FIGS. 3-4, 5A-5C, 6-9, and 10A-10B.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects are provided by the subject matter of the following clauses:
A method of operating a turbine engine having a compressor section, a combustion section, and a turbine section in a serial flow arrangement, the combustion section comprising a fuel mixer assembly, wherein the fuel mixer assembly comprises a mixing tube body defining a mixing channel, and a fuel source fluidly coupled to the mixing channel, the method comprising: supplying air to the mixing channel; supplying fuel to the mixing channel from a first set of fuel passages at a first axial position when the turbine engine is at low power conditions; supplying fuel to the mixing channel from a second set of fuel passages at a second axial position, upstream of the first axial position, when the turbine engine is at high power conditions; mixing the fuel and the air to form a fuel-air mixture; and providing the fuel-air mixture to a combustion chamber.
The method of any proceeding clause, wherein the fuel mixer assembly further includes a centerbody extending from a fore end of the mixing tube body into the mixing channel, wherein the supplying the air to the mixing channel includes at least two air streams, wherein the at least two air streams comprise a first air stream passing through the centerbody and a second air stream passing over a centerbody outer surface.
The method of any proceeding clause, wherein the centerbody defines a centerbody air passage, and wherein the first air stream is supplied by the centerbody air passage.
The method of any proceeding clause, wherein a fore end of the mixing tube body at least partially defines a plurality of apertures, wherein the second air stream is supplied by the plurality of apertures.
The method of any proceeding clause, wherein the supplying the fuel to the mixing channel from the second set of fuel passages includes supplying the fuel between the at least two air streams.
The method of any proceeding clause, wherein at least one of the at least two air streams is a swirled air stream.
The method of any proceeding clause, wherein the swirled air stream has a swirl number greater than 0 and less than or equal to 0.4.
The method of any proceeding clause, wherein the supplying the fuel to the mixing channel from the first set of fuel passages or the second set of fuel passages includes supplying a swirled fuel stream.
The method of any proceeding clause, wherein the swirled fuel stream has a swirl number greater than 0 and less than or equal to 0.4.
The method of any proceeding clause, wherein the supplying the air to the mixing channel includes at least two air streams, wherein at least one of the at least two air streams is a swirled air stream.
The method of any proceeding clause, wherein each of the swirled fuel stream and swirled air stream have a swirl number greater than or equal to 0 and less than or equal to 0.4.
The method of any proceeding clause, further comprising imparting turbulence on fuel, air, or a combination thereof via turbulators defined in the mixing tube body and located between the first axial position and the second axial position.
The method of any proceeding clause, wherein a tube centerline is defined centrally within the mixing tube body, and the supplying the fuel to the mixing channel from the first set of fuel passages or the second set of fuel passages includes supplying the fuel in a direction offset from parallel to the tube centerline.

The method of any proceeding clause, wherein the fuel mixer assembly includes a centerbody extending from a fore end of the mixing tube body into the mixing channel, and the supplying the air to the mixing channel includes obstructing and imparting turbulence on a portion of the air by at least the centerbody.
The method of any proceeding clause, wherein the centerbody has a centerbody outer surface at least partially defining a set of fuel posts, the set of fuel posts extend radially outward from the centerbody outer surface, wherein the supplying air to the mixing channel includes obstructing and imparting turbulence on a portion of the air by the set of fuel posts.
The method of any proceeding clause, wherein a tube centerline is defined centrally within the mixing tube body, the second set of fuel passages includes a second set of fuel orifices and the supplying the fuel to the mixing channel from the second set of fuel passages is at an angle greater than or equal to 10° and less than or equal to 60° defined between a central axis of each orifice in the second set of fuel orifices and the tube centerline.
The method of any proceeding clause wherein fuel is supplied to the mixing channel from both the first set of fuel passages and the second set of fuel passages at low power conditions or high power conditions.
The method of any proceeding clause, wherein the fuel mixer includes a swirler at a fore end of the centerbody and air entering the centerbody is swirled by the swirler.
The method of any proceeding clause, wherein the set of fuel posts define a fuel post extension distance measured from a fuel post base to a fuel post tip and the fuel post extension distance is greater than 5% and less than or equal to 10% of an exit diameter

A turbine engine comprising: a compressor section, combustion section, and turbine section in serial flow arrangement, with the combustion section having a fuel source, an air source, and a fuel mixer assembly comprising: a mixing tube body at least partially defining a mixing channel; a fore end of the mixing tube body fluidly coupling the air source to the mixing channel; a first set of fuel passages and a second set of fuel passages fluidly coupling the fuel source to the mixing channel, wherein the first set of fuel passages supplies fuel at a first axial position of the mixing channel at low power conditions and the second set of fuel passages supplies fuel at a second axial position of the mixing channel, upstream of the first axial position, at high power conditions.

The turbine engine of any proceeding clause, wherein the fuel mixer assembly includes a centerbody extending from a fore end of the mixing tube body into the mixing channel, and an air passage defined in an inner surface of the centerbody.

The turbine engine of any proceeding clause, wherein the first set of fuel passages are at least partially defined in the mixing tube body.

The turbine engine of any proceeding clause, wherein the second set of fuel passages are at least partially defined in an outer surface of the centerbody.

The turbine engine of any proceeding clause, wherein the centerbody has a centerbody outer surface at least partially defining a set of fuel posts, the set of fuel posts has a set of first set of fuel orifices fluidly coupled to the first set of fuel passages, where the set of fuel posts extend a distance toward a center of the mixing channel.

The turbine engine of any proceeding clause, wherein the fore end of the mixing tube body supplies air to the mixing channel, and the set of fuel posts obstructs and imparts turbulence on a portion of the air.

The turbine engine of any proceeding clause, wherein a first air stream is passed through the centerbody and a second air stream passing over a centerbody outer surface.

The turbine engine of any proceeding clause, wherein the centerbody defines a centerbody air passage, and the centerbody air passage supplies the first air stream.

The turbine engine of any proceeding clause, wherein a fore end of the mixing tube body at least partially defines a plurality of apertures, and the plurality of apertures supplies the second air stream.

The turbine engine of any proceeding clause, wherein the second set of fuel passages supplies fuel between the first air stream and the second air stream.

The turbine engine of any proceeding clause, wherein at least one of the first air stream and the second air stream is a swirled air stream.

The turbine engine of any proceeding clause, wherein the swirled air stream has a swirl number greater than 0 and less than or equal to 0.4.

The turbine engine of any proceeding clause, wherein fuel supplied from at least one of the first set of fuel passages and the second set of fuel passages is a swirled fuel stream.

The turbine engine of any proceeding clause, wherein the swirled fuel stream has a swirl number greater than 0 and less than or equal to 0.4.

The turbine engine of any proceeding clause, wherein the fuel mixer assembly further includes turbulators defined in the mixing tube body, wherein the turbulators are located between the first axial position and the second axial position.

The turbine engine of any proceeding clause, wherein a tube centerline is defined centrally within the mixing tube body, and at least one of the first set of fuel passages and the second set of fuel passages supplies fuel in a direction offset from parallel to the tube centerline.

The turbine engine of any proceeding clause, wherein the fore end of the mixing tube body supplies air to the mixing channel, and the centerbody obstructs and imparts turbulence on a portion of the air.

The turbine engine of any proceeding clause, wherein a tube centerline is defined centrally within the mixing tube body, the second set of fuel passages includes a second set of fuel orifices, and the second set of fuel passages supplies fuel to the mixing channel at an angle greater than or equal to 10° and less than or equal to 60° defined between a central axis of each orifice in the second set of fuel orifices and the tube centerline.

The turbine engine of any proceeding clause, wherein the second set of fuel orifices is oriented radially outward with respect to the tube centerline.

The turbine engine of any proceeding clause, wherein a tube centerline is defined centrally within the mixing tube body, the first set of fuel passages includes a first set of fuel orifices, and the first set of fuel passages supplies fuel to the mixing channel at an angle greater than or equal to 10° and less than or equal to 140° defined between a central axis of each orifice in the first set of fuel orifices and the tube centerline.

The turbine engine of any proceeding clause, wherein fuel supplied from at least one of the first set of fuel passages and the second set of fuel passages is a swirled fuel stream and at least one of the first air stream and the second air stream is a swirled air stream.

The turbine engine of any proceeding clause, wherein the swirled fuel stream is co swirled relative to the swirled air stream.

The turbine engine of any proceeding clause, wherein the swirled fuel stream is counter swirled relative to the swirled air stream.

The turbine engine of any proceeding clause, wherein the first air stream and the second air stream are co swirled air streams.

The turbine engine of any proceeding clause, wherein the first air stream and the second air stream are counter swirled air streams.

The turbine engine of any proceeding clause, wherein fuel is supplied to the mixing channel from both the first set of fuel passages and the second set of fuel passages at low power conditions or high power conditions.

The turbine engine of any proceeding clause, wherein the fuel mixer includes a swirler at a fore end of the centerbody and air entering the centerbody is swirled by the swirler.

The turbine engine of any proceeding clause, wherein the set of fuel posts define a fuel post extension distance measured from a fuel post base to a fuel post tip and the fuel post extension distance is greater than 5% and less than or equal to 10% of an exit diameter.

A fuel mixer assembly comprising: a mixing tube body at least partially defining a mixing channel; a fore end of the mixing tube body fluidly coupling the air source to the mixing channel; a first set of fuel passages and a second set of fuel passages fluidly coupling the fuel source to the mixing channel, wherein the first set of fuel passages supplies fuel at a first axial position of the mixing channel at low power conditions and the second set of fuel passages supplies fuel at a second axial position of the mixing channel, upstream of the first axial position, at high power conditions.

The fuel mixer assembly of any proceeding clause, wherein the fuel mixer assembly includes a centerbody extending from a fore end of the mixing tube body into the mixing channel, and an air passage defined in an inner surface of the centerbody.

The fuel mixer assembly of any proceeding clause, wherein the first set of fuel passages are at least partially defined in the mixing tube body.

The fuel mixer assembly of any proceeding clause, wherein the second set of fuel passages are at least partially defined in an outer surface of the centerbody.

The fuel mixer assembly of any proceeding clause, wherein the centerbody has a centerbody outer surface at least partially defining a set of fuel posts, the set of fuel posts has a set of first set of fuel orifices fluidly coupled to the first set of fuel passages, where the set of fuel posts extend a distance toward a center of the mixing channel.

The fuel mixer assembly of any proceeding clause, wherein the fore end of the mixing tube body supplies air to the mixing channel, and the set of fuel posts obstructs and imparts turbulence on a portion of the air.

The fuel mixer assembly of any proceeding clause, wherein a first air stream is passed through the centerbody and a second air stream passing over a centerbody outer surface.

The fuel mixer assembly of any proceeding clause, wherein the centerbody defines a centerbody air passage, and the centerbody air passage supplies the first air stream.

The fuel mixer assembly of any proceeding clause, wherein a fore end of the mixing tube body at least partially defines a plurality of apertures, and the plurality of apertures supplies the second air stream.

The fuel mixer assembly of any proceeding clause, wherein the second set of fuel passages supplies fuel between the first air stream and the second air stream.

The fuel mixer assembly of any proceeding clause, wherein at least one of the first air stream and the second air stream is a swirled air stream.

The fuel mixer assembly of any proceeding clause, wherein the swirled air stream has a swirl number greater than 0 and less than or equal to 0.4.

The fuel mixer assembly of any proceeding clause, wherein fuel supplied from at least one of the first set of fuel passages and the second set of fuel passages is a swirled fuel stream.

The fuel mixer assembly of any proceeding clause, wherein the swirled fuel stream has a swirl number greater than 0 and less than or equal to 0.4.

The fuel mixer assembly of any proceeding clause, wherein the fuel mixer assembly further includes turbulators defined in the mixing tube body, wherein the turbulators are located between the first axial position and the second axial position.

The fuel mixer assembly of any proceeding clause, wherein a tube centerline is defined centrally within the mixing tube body, and at least one of the first set of fuel passages and the second set of fuel passages supplies fuel in a direction offset from parallel to the tube centerline.

The fuel mixer assembly of any proceeding clause, wherein the fore end of the mixing tube body supplies air to the mixing channel, and the centerbody obstructs and imparts turbulence on a portion of the air.

The fuel mixer assembly of any proceeding clause, wherein a tube centerline is defined centrally within the mixing tube body, the second set of fuel passages includes a second set of fuel orifices, and the second set of fuel passages supplies fuel to the mixing channel at an angle greater than or equal to 10° and less than or equal to 60° defined between a central axis of each orifice in the second set of fuel orifices and the tube centerline.

The fuel mixer assembly of any proceeding clause, wherein the second set of fuel orifices is oriented radially outward with respect to the tube centerline.

The fuel mixer assembly of any proceeding clause, wherein a tube centerline is defined centrally within the mixing tube body, the first set of fuel passages includes a first set of fuel orifices, and the first set of fuel passages supplies fuel to the mixing channel at an angle greater than or equal to 10° and less than or equal to 140° defined between a central axis of each orifice in the first set of fuel orifices and the tube centerline.

The fuel mixer assembly of any proceeding clause, wherein fuel supplied from at least one of the first set of fuel passages and the second set of fuel passages is a swirled fuel stream and at least one of the first air stream and the second air stream is a swirled air stream.

The fuel mixer assembly of any proceeding clause, wherein the swirled fuel stream is co swirled relative to the swirled air stream.

The fuel mixer assembly of any proceeding clause, wherein the swirled fuel stream is counter swirled relative to the swirled air stream.

The fuel mixer assembly of any proceeding clause, wherein the first air stream and the second air stream are co swirled air streams.

The fuel mixer assembly of any proceeding clause, wherein the first air stream and the second air stream are counter swirled air streams.

The fuel mixer assembly of any proceeding clause, wherein fuel is supplied to the mixing channel from both the first set of fuel passages and the second set of fuel passages at low power conditions or high power conditions.

The fuel mixer assembly of any proceeding clause, wherein the fuel mixer includes a swirler at a fore end of the centerbody and air entering the centerbody is swirled by the swirler.

The fuel mixer assembly of any proceeding clause, wherein the set of fuel posts define a fuel post extension distance measured from a fuel post base to a fuel post tip and the fuel post extension distance is greater than 5% and less than or equal to 10% of an exit diameter.

1. A method of operating a turbine engine having a compressor section, a combustion section, and a turbine section in a serial flow arrangement, the combustion section comprising a fuel mixer assembly, wherein the fuel mixer assembly comprises a mixing tube body defining a mixing channel, and a fuel source fluidly coupled to the mixing channel, the method comprising:
supplying air to the mixing channel from a first air stream of a pair of air streams passing through a centerbody air passage having a center body inner surface configured to impart a degree of swirl to the first air stream;
supplying fuel to the mixing channel from a first set of fuel passages at a first axial position when the turbine engine is at low power conditions, wherein the first set of fuel passages is downstream of the first air stream and angled with respect to a tube centerline defined centrally within the mixing tube body;
supplying fuel to the mixing channel from a second set of fuel passages at a second axial position, upstream of the first axial position, when the turbine engine is at high power conditions;
mixing the fuel and the air to form a fuel-air mixture; and
providing the fuel-air mixture to a combustion chamber.

2. The method of claim 1, wherein the fuel mixer assembly further includes a centerbody extending from a fore end of the mixing tube body into the mixing channel, wherein the centerbody defines the centerbody air passage, wherein the supplying the air to the mixing channel includes supplying the air from at least the pair of air streams, wherein the pair of air streams comprise the first air stream passing through the centerbody and a second air stream passing over a centerbody outer surface.

3. (canceled)

4. The method of claim 2, wherein a fore end of the mixing tube body at least partially defines a plurality of apertures, wherein the second air stream is supplied by the plurality of apertures.

5. The method of claim 2, wherein the supplying the fuel to the mixing channel from the second set of fuel passages includes supplying the fuel between the at least two air streams such that the fuel is straddled by the first air stream and the second air stream to promote mixing of the fuel from the second set of fuel passages with the at least two air streams.

6. The method of claim 2, wherein at least one of the at least two air streams is a swirled air stream.

7. (canceled)

8. The method of claim 1, wherein the supplying the fuel to the mixing channel from the first set of fuel passages or the second set of fuel passages includes supplying a swirled fuel stream.

9. The method of claim 8, wherein the swirled fuel stream has a swirl number greater than 0 and less than or equal to 0.4.

10. The method of claim 9, wherein the supplying the air to the mixing channel includes at least two air streams, wherein at least one of the at least two air streams is a swirled air stream.

11. The method of claim 10, wherein each of the swirled fuel stream and swirled air stream have a swirl number greater than or equal to 0 and less than or equal to 0.4.

12. The method of claim 1, further comprising imparting turbulence on fuel, air, or a combination thereof via turbulators defined in the mixing tube body and located between the first axial position and the second axial position.

13. The method of claim 1, wherein supplying the fuel to the mixing channel from the second set of fuel passages includes supplying the fuel in a direction offset from parallel to the tube centerline.

14. The method of claim 1, wherein the fuel mixer assembly includes a centerbody extending from a fore end of the mixing tube body into the mixing channel, and the supplying the air to the mixing channel includes obstructing and imparting turbulence on a portion of the air by at least the centerbody.

15. The method of claim 14, wherein the centerbody has a centerbody outer surface at least partially defining a set of fuel posts, the set of fuel posts extend radially outward from the centerbody outer surface, wherein the supplying air to the mixing channel includes obstructing and imparting turbulence on a portion of the air by the set of fuel posts.

16. The method of claim 15, wherein a tube centerline is defined centrally within the mixing tube body, the second set of fuel passages includes a second set of fuel orifices and the supplying the fuel to the mixing channel from the second set of fuel passages is at an angle greater than or equal to 10° and less than or equal to 60° defined between a central axis of each orifice in the second set of fuel orifices and the tube centerline.

17. A turbine engine comprising:
a compressor section, combustion section, and turbine section in serial flow arrangement, with the combustion section having a fuel source, an air source including a pair of air streams, wherein a first air stream of the pair of air streams flows through a centerbody air passage having a centerbody inner surface configured to impart a degree of swirl to the first air stream, and a fuel mixer assembly comprising:
a mixing tube body at least partially defining a mixing channel;
a fore end of the mixing tube body fluidly coupling the air source to the mixing channel; and
a first set of fuel passages and a second set of fuel passages fluidly coupling the fuel source to the mixing channel, wherein the first set of fuel passages supplies fuel at a first axial position of the mixing channel at low power conditions and the second set of fuel passages supplies fuel at a second axial position of the mixing channel, upstream of the first axial position, at high power conditions, wherein the first set of fuel passages is downstream of at least one of the pair of air streams.

18. The turbine engine of claim 17, wherein the fuel mixer assembly includes a centerbody extending from a fore end of the mixing tube body into the mixing channel, and an air passage defined in an inner surface of the centerbody and configured to direct a first air stream of the pair of air streams, wherein the first set of fuel passages is angled with respect to a tube centerline defined centrally within the mixing tube body.

19. The turbine engine of claim 18, wherein the first set of fuel passages are at least partially defined in the mixing tube body.

20. The turbine engine of claim 18, wherein the second set of fuel passages are at least partially defined in an outer surface of the centerbody.

21. The method of claim 1, further comprising:
when the turbine engine is transitioning between low power conditions and high power conditions, supplying fuel to the mixing channel from both the first set of fuel passages and the second set of fuel passages.
